(19) United States
(12) Patent Application Publication
(10) Pub. No.: US 2022/0301061 A1
(43) Pub. Date: Sep. 22, 2022

(54) System and Method for Associating Business Owners and Business Investors

(71) Applicant: Sapna Rajput, South Plainfield, NJ (US)

(72) Inventor: Sapna Rajput, South Plainfield, NJ (US)

(21) Appl. No.: 17/411,105

(22) Filed: Aug. 25, 2021

Related U.S. Application Data
(60) Provisional application No. 63/161,674, filed on Mar. 16, 2021.

(51) Int. Cl. G06Q 40/06; G06F 16/9535; G06Q 30/08

(52) U.S. Cl. CPC G06Q 40/06; G06F 16/9535; G06Q 30/08

(57) ABSTRACT

The present invention relates to a method and system for connecting business owners with business investors. The business owners can search for potential business investors based on preferred selection criteria and the business investors can also search for businesses to invest as per their preferences. Registration data of business owners is collected through a business owner registration portal and registration data of business investors is collected through business investors registration portal. A recommendation engine recommends businesses for investment based on the collected registration data of the business owners. A plurality of business investors can bid for investing and a business owner can select one or more business investors for investment. The system optimizes the search process of looking for business investors and investment opportunities.

### CROSS-REFERENCE TO RELATED APPLICATION

The present application claims priority to, and the benefit of, U.S. Provisional Application No. 63/161,674, which was filed on Mar. 16, 2021 and is incorporated herein by reference in its entirety.

### FIELD OF THE INVENTION

The present invention generally relates to matching business owners who need financial investment with business investors who want to provide investment. More specifically, the present invention relates to a system and computer-implemented application designed to register business owners and business investors and associate the business owners and business investors for the purpose of facilitating investments. The profiles of the business owners, details of the businesses and projects and profiles of the business investors are used for associating projects and business owners with the business investors. The business owner can set a condition for investment in the project and one or more business investors can bid for a project. The business owner can then select or reject one or more business investors. Accordingly, the present disclosure makes specific reference thereto. Nonetheless, it is to be appreciated that aspects of the present invention are also equally applicable to other like applications, devices, and methods.

### BACKGROUND OF THE INVENTION

By way of background, a business owner or entrepreneur may require financial investment to expand or launch a business. Investment is crucial for a new business that has not yet generated revenue. The investment needs to be maintained until a business is able to generate revenue and become financially sustainable. Often, the business owner does not know how to obtain financial investments and is not aware of potential business investors. The business owner may not know how to locate a qualified business investor, and once potential business investors are located, the company may not know how to contact, communicate with and present to the business investor in an efficient manner.

Similarly, business investors have a need to quickly locate profitable businesses in which to invest. When investors find profitable businesses, they will compete with other investors as all investors are motivated by a return on their investment. It may be difficult for the business investors to find businesses in which to invest as per their preferences. Business investors have limited resources to research and select potential companies for investing. Even when a potential company is found, the business investors may end up investing in a fraudulent business unless the business investor takes time to verify the legitimacy of the company.

Business owners and business investors have common requirements for a successful investment. Successfully associating business owners and business investors is not easy, especially during pandemics, or when the business owner and business investor are not geographically close to each other, or under other circumstances when face-to-face meetings are not possible between the business owners and the business investors. The investment industry does not have an efficient capital marketplace in which business investors can find businesses to fund, and business owners cannot find, in a time-efficient manner, capital when they need it most.

Therefore, there exists a long-felt need in the art for a computer program, method and system that enables business owners to find potential business investors in a simplified and efficient manner. There is also a long-felt need in the art for a computer program, method and system that enables business investors to easily and conveniently find businesses in which to invest. Additionally, there is a long-felt need in the art for a computer program, method and system that allows businesses to set terms and conditions for investments. Moreover, there is a long-felt need in the art for a computer program, method and system that facilitates computer-implemented communication methods for interaction between business investors and business owners. Furthermore, there is a long-felt need in the art for a computer program, method and system that allows the business investors to quickly bid for investments in a business, and allows the business owners to quickly select or reject any investment. Finally, there is a long-felt need in the art for a computer program, method and system that associates compatible business owners and business investors for quick and efficient funding and investment.

The subject matter disclosed and claimed herein, in one embodiment thereof, comprises a computer-implemented application for matching business owners with business investors. The application may contain a non-transitory, computer-readable storage medium with an executable program stored thereon, wherein the program instructs a processor to receive registration details from one or more business owners wherein the registration details for each business owner includes personal details, business information, and investment terms and conditions, receive registration details from one or more business investors wherein the registration details for each business investor includes personal details and investment preferences of the business investor, create categories of businesses based on the business information, match investment preferences of the business investors with the business categories and terms and conditions of the business owners, recommend one or more businesses to the business investors for investment, and provide a list of potential business investors to the business owners. Once an interest is shown by a business investor in a business, the business owner is notified, and the processor provides a means for communication to the business owner and business investor.

In this manner, the novel computer program, method, and system of the present invention accomplishes all the forgoing objectives, and provides a relatively safe, easy, convenient and efficient solution for business owners to find business investors and for business investors to find businesses in which to invest. The system affords entrepreneurs the opportunity to maximize funding as per their preferences and optimizes the search process of looking for business investors and investment opportunities. The business owners and business investors can schedule a meeting/phone call to quicken the investment process.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a non-transitory, computer-readable storage medium with an executable program stored thereon, wherein the program instructs a processor to receive registration details from one or more business owners wherein the registration details for each business owner includes personal details, business information, and investment terms and conditions. The program receives registration details from one or more business investors wherein the registration details for each business investor include personal details, investment preferences of the business investor and categories of business investments based on the business information. The program matches the investment preferences of the business investors with the business categories and terms and conditions of the business owners, and recommends one or more businesses to the business investors for investment and provides a list of potential business investors to the business owners. Once an interest is shown by a business investor in a business, the business owner is notified, and the processor provides a means for communication to the business owner and business investor.

In a further embodiment of the present invention, a system for connecting business investors with business owners is disclosed. The system includes a business owner portal for registering business owners, the registration information includes personal details, business information and desired investment details. The system also includes a business investor portal for registering business investors, the business investor registration information includes personal details and investment preferences. The business owners' registration information is stored in the business owners' database and the business investors' registration information is stored in the business investors database. There is a categorization module categorizing the businesses in one or more categories and sub-categories based on business information, and a recommendation engine recommending businesses for investment to business investors based on the category, business location and investment preferences. A business investor can search for potential businesses using one or more filtering criteria. Similarly, a business owner can search for potential business investors using one or more filtering criteria. A business owner can also select one or more business investors when a plurality of business investors bid for investment in a single business.

In a further embodiment of the present invention, a method for matching business owners and business investors is described. The method includes receiving requests for investment from a plurality of business owners wherein each business owner describes the location, business type and investment conditions; associating one or more requests for investment with one or more potential business investors who can provide investments wherein the association is based on the matching of the preferred affinities of the business investors with the category, location and investment terms of the business owner, and notifying the business owner of bidding of one or more business investors for the investment in the business of the business owner.

In yet a further embodiment of the present invention, a computer software-supported system for selecting one or more business investors for investing in a business is disclosed. The system includes a portal for business owners to show details of the business investors who have bid to invest in a business of a business owner. The portal receives selections of one or more business investors by the business owner for investing in the business and includes a notification module that sends a notification to each business investor selected by the business owner for a discussion on the potential investment.

In yet a further embodiment of the present invention, a list of business investors whose preferred location for investment matches with the location of a business requesting investment are recommended to the business owner of the business. Similarly, a list of businesses based on the preferred investment location and category of the business investor are shown to the business investor. The business owner can view the latest investments of potential business investors before selecting a business investor.

In a further embodiment of the present invention, the business investors can be categorized into a plurality of categories based on business or technology segments, investment amount, type of business or other parameters. The business investors can be ranked based on successful investments and amount of investment.

In one embodiment, a business owner can upload a business information brochure, a promotional video of the business, a business history or an idea of the business along with any internet addresses to increase the credibility of the information. The business owners' details and business investors' details are verified by the system of the present invention allowing only verified business owners and business investors to be listed on the portal.

The communication method between a selected business investor and business owner has been disclosed in terms of communicating via the internet; however, in accordance with other embodiments, various other communication networks may be used in practicing the present invention, or alternatively, the communication may be conducted through face-to-face meetings. A central customer support service with marketing, financial and technological experts can also be a part of the system of the present invention to facilitate communication and negotiations between a business owner and a business investor.

To the accomplishment of the foregoing and related ends, certain illustrative aspects of the disclosed innovation are described herein in connection with the following description and the annexed drawings. These aspects are indicative; however, of but a few of the various ways in which the principles disclosed herein can be employed and are not intended to include all such aspects and their equivalents. Other advantages and novel features will become apparent from the following detailed description when considered in conjunction with the drawings.

### BRIEF DESCRIPTION OF THE DRAWINGS

The description refers to the provided drawings in which similar reference characters refer to similar parts throughout the different views, and in which:

FIG. 1 illustrates a schematic diagram showing use of computer-implemented application for matching business owners with business investors in the system of the present invention in accordance with the disclosed architecture;

FIG. 2 illustrates a flow diagram showing steps performed by a business owner for registering a business on the system of the present invention in accordance with the disclosed architecture;

FIG. 3 illustrates a flow diagram showing steps performed by a business investor for registering on the system of the present invention in accordance with the disclosed architecture;

FIG. 4 illustrates a perspective view of a recommendation engine used in the system of the present invention for matching business owners with business investors in accordance with the disclosed architecture;

FIG. 5 illustrates a flow diagram showing steps for performing a bid by a business investor for a project using the system of the present invention in accordance with the disclosed architecture;

FIG. 6 illustrates a flow chart illustrating steps for automatically matching business owners with business investors for investments using the computer-implemented method of the present invention in accordance with the disclosed architecture;

FIG. 7 illustrates a perspective view of an exemplary interface for submitting a business/project for investment on the system of the present invention in accordance with the disclosed architecture;

FIG. 8 illustrates a perspective view of an exemplary interface showing investment bidding status for a project on the system of the present invention in accordance with the disclosed architecture; and

FIG. 9 illustrates an exemplary interface of the system of the present invention for enabling a business investor to search for businesses in which to invest based on certain search criteria in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth to provide a thorough understanding thereof. It may be evident; however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a computer program, method and system that enables businesses to find potential business investors in a simplified manner. There is also a long-felt need in the art for a computer program, method and system that enables business investors to find businesses in which to invest easily and conveniently. Additionally, there is a long-felt need in the art for a computer program, method, and system that allows businesses to set terms and conditions for investments. Moreover, there is a long-felt need in the art for a computer program, method, and system that facilitates computer-implemented communication methods for interaction between business investors and business owners. Furthermore, there is a long-felt need in the art for a computer program, method and system that allows the business investors to quickly bid for investment in a business and allows the business owners to select or reject any investment quickly and easily. Finally, there is a long-felt need in the art for a computer program, method and system that associates compatible businesses and business investors in a quick and efficient process.

The present invention, as disclosed in one exemplary embodiment, is a novel system for connecting business investors with business owners. The system includes a business owner portal for registering business owners. The registration information includes personal details, business information and desired investment details. The system also includes a business investor portal for registering business investors. The business investor registration information includes personal details and investment preferences. The business owners' registration information is stored in the business owners' database, and the business investors' registration information is stored in the business investors database; a categorization module categorizing the businesses in one or more categories based on business information, and a recommendation engine recommends businesses for investment to business investors based on the preferred category, business location and investment preferences. A business investor can search for potential businesses using one or more filtering criteria. A business owner can select one or more business investors when a plurality of business investors bid for investment on a single business.

The computer-implemented application or instruction of the present invention is executed by a processor of an electronic device. The device may include a wireless communication module, a touchscreen driver module, a touch-based application module, a display output module and/or other modules. The modules may be implemented in software, hardware, firmware or some combination thereof. The server and recommendation engine used in the present invention may also be implemented in software, hardware, firmware or some combination thereof.

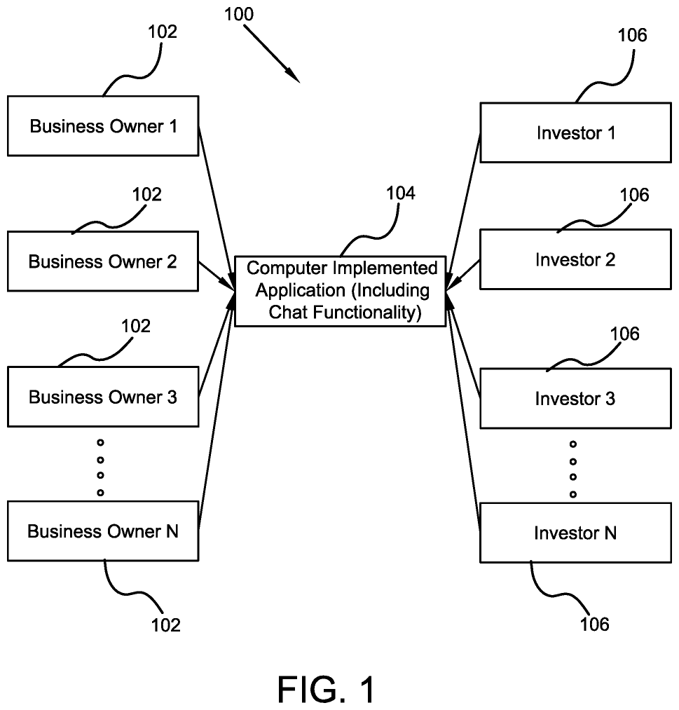

Referring initially to the drawings, FIG. 1 illustrates a schematic diagram showing use of a computer-implemented application for matching business owners with business investors 100 of the present invention in accordance with the disclosed architecture. To use the application 100, a user can register as a business owner 102 or as a business investor 106. The interface shown to a user is based on their user profile, which labels them a business owner 102 or as a business investor 106. Further, the one or more business owners 102 can include owners of established businesses looking to expand, or entrepreneurs attempting to establish start-up companies. The one or more business investors 106 may include investment institutions or individual business investors who wish to invest directly with a business owner 102. The system 100 uses a computer-implemented software application 104, or a web-based software application that enables business owners 102 to find business investors 106 for their businesses. The business investors 106 can also search for potential businesses in which to invest as per their preferences (e.g. their potential investment interests) and their geographical location. Each business owner 102 may have the computer implemented mobile software application 104 installed on their electronic smart device or may use a web-based application. Similarly, each business investor 106 may have the computer-implemented mobile software application 104 installed on their respective electronic smart devices or may use a web-based application. The computer-implemented application 104 receives requests from business owners 102 for the investment they seek for their projects or businesses. On a portal 700 provided by the application 104, the business owners 102 create a profile and provide their business details, terms and conditions of any investment and other preferences to govern the investment in a listing. The listing may also include how much money the business owner 102 is seeking for what percentage of the business, a description of the investment opportunity, the number of investors 106 interested in the listing, and a date wherein bidding on the business is open until.

Each business investor 106 registers on the computer-implemented application 104 and creates a profile. Preferences for business ideas or for start-up companies in which they seek to invest can be included in the profile. The computer-implemented application 104 evaluates the business ideas based on their description, categorizes the business into one or more categories and matches the business investors 106 to businesses based on the preferences chosen by the business investors 106 and the business owners 102. As best shown in FIG. 1, in a preferred embodiment, the computer-implemented application 104 will also have chat functionality, thereby allowing the business investors 106 and the business owners 102 to communicate directly with one another.

The computer-implemented application 104 receives input using the input devices such as a touchpad or keyboard of an electronic device and displays the application using output devices such as a display unit of the electronic device. Based on the preferences of the business investors, the application 104, using a recommendation engine, recommends one or more businesses for investment. The business investors 106 can also bid against other business investors 106 for providing investments to a business owner 102 for their project or business until a certain date, as shown in the listing. The business owner 102 can then view how many investors 106 are interested in their listing and select one or more business investors 106 from a list of interested business investors for investment in the business. The owner 102 can also view what dollar amount and what percentage stake in the business each investor 106 has proposed to invest. Further, the business owner 102 can then schedule a meeting or a phone call with the selected business investor.

In a variation of this embodiment, respective business owners 102 and business investors 106 may directly negotiate with each other via the computer-implemented application 106. It should be appreciated that the computer-implemented application 104 can provide real-time notifications regarding the activities taking place on the listed business or investment.

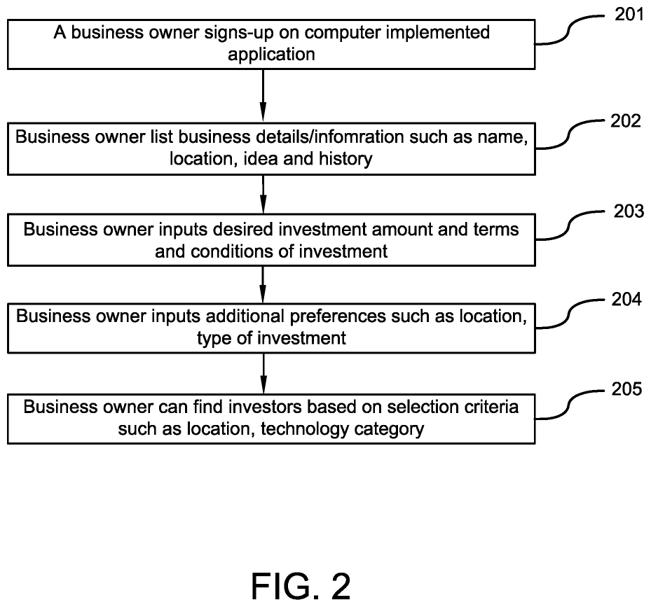

FIG. 2 illustrates a flow diagram showing steps performed by a business owner for registering a business on the computer-implemented application of the present invention in accordance with the disclosed architecture. As shown, initially, a business owner signs-up or registers on the computer-implemented application (Block 201). During the sign-up process, business owners 102 provide personal information such as the business owner name, address and contact details. Further, business details or information such as the business name, location, picture, promotional video, business idea information, business history, financial information such as the firm's estimates and actuals for one or more of: sales, earnings, cash flow, return on assets, debt structure, liabilities, assets, current assets, quick ratio, taxes, or like types of financial parameters, are also provided (Block 202). Then, the business owner 102 provides a desired investment amount (e.g. monetary value and investment percentage stake), the terms and conditions of the investment such as stakes in return for the investment amount and the type of investment (Block 203).

The business owner 102 can also input additional preferences of business investors such as location, type of investment or the like (Block 204). Following these steps, the business owner 102 creates a profile and lists a potential business for seeking investment from a business investor 106. Once the profile is created, the business is listed on the application and is discoverable using one or more search keywords or categories. The business owner 102 can find potential business investors 106 based on selection criteria such as location or technology category for obtaining funds for their business (Block 205). The application 100 also offers a search bar to find potential business investors based on a plurality of search criteria.

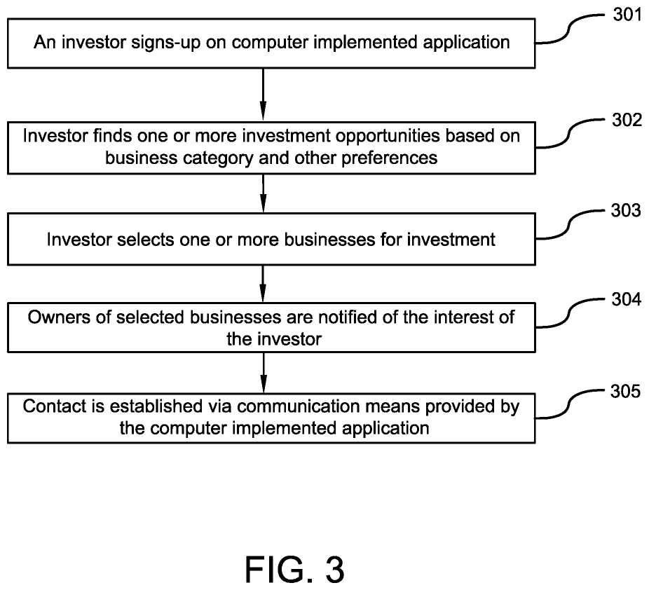

FIG. 3 illustrates a flow diagram showing steps performed by a business investor 106 for registering on the computer-implemented application 100 of the present invention in accordance with the disclosed architecture. As shown, initially, a business investor 106 signs-up or registers on the computer-implemented application (Block 301). The application has two modules that can be selected at the loading screen of the application 100, one for the business owner 102 and one for the business investor 106. The business investor 106 registers using the business investor module. During registration, the business investor 106 inputs information such as name, address, contact details, preferred business category and location for investing, as well as other details that would be helpful in identifying a potential business for investment. Once the sign-up process is complete, the business investor 106 can find one or more investment opportunities based on the business category and other preferences of the business investor (Block 302). The application can recommend businesses for investment based on the profile of the business investor. Then, the business investor 106 can view and compare the various businesses with the associated investment requests and conditions. The business investor 106 can then select one or more businesses of choice per the preferences for making an investment (Block 303).

The owners 102 of the selected one or more businesses receive a notification indicating interest of the business investor 106 in the owners' 102 business (Block 303). The notification can be in the form of an email, a push notification, an SMS or an instant message. Then, based on the choices and preferences of the business owners 102, the owners 102 can use the application 100 to select or reject the request of the business investor 106 after viewing the bid of the investor 106 which includes the monetary value and percentage stake of the bid. When the request is accepted by the business owners 102, a contact is established via a communication means provided by the computer-implemented application (Block 305).

Further, in Block 305, the business owner 102 can schedule a meeting or a phone call with the business investor 106 who has shown interest in investing in the business owner's 102 idea. The application 100 may also provide the notification to the terminal associated with the business investor having information related to the business ideas in which the business investor may be interested in investing funds.

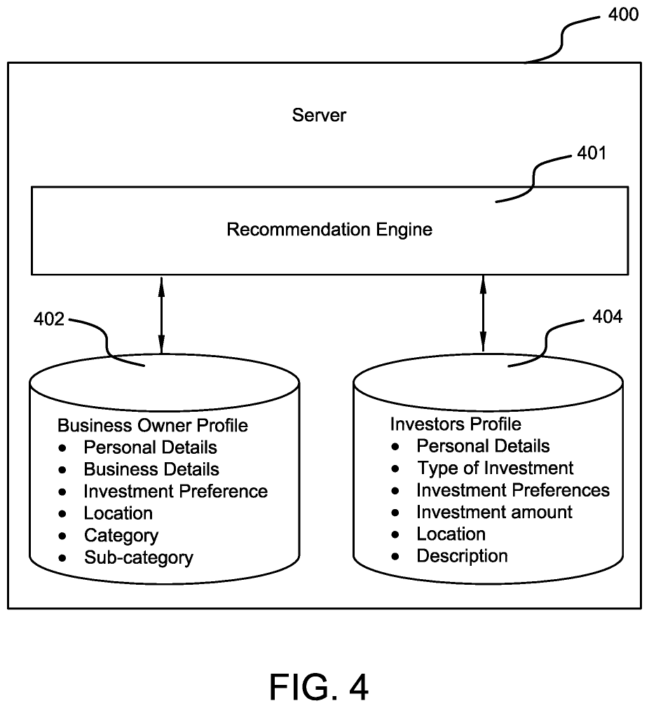

FIG. 4 illustrates a perspective view of a recommendation engine 401 used in the system of the present invention for matching business owners with business investors 100 in accordance with the disclosed architecture. A server 400 is coupled to the application 100 of the present invention and has a recommendation engine 401 to automatically recommend businesses for investment to business investors 106 and recommend business investors 106 to business owners 102. The recommendation engine 401 is coupled to a business owner profile database 402 and a business investor profile database 403. The business owner profile database 402 has information related to the business owner such as personal details, business details, investment preferences, location, category, sub-category and other business details. The information is collected during the registration process of a business owner 102 and is updated based on the interaction with the application 100. The investor profile database 403 has information related to the business investors such as personal details, investment preferences, threshold investment amount, location, investment description and other such investment details. The recommendation engine 401 collectively analyzes the data related to the business owner and the business investor from the business owner profile database 402 and the business investor profile database 403 and recommends relevant results based on the collaborative filtering.

The recommendation engine 401 also evaluates the business ideas and matches the business investors 106 with the business owners 102 based on factors chosen by the business investors 106 and the business owners 102. For example, the recommendation engine 401 matches the investment preference information in the business owner profile database 402 with the investment preference information in the business investor profile database 403 and matches the business investors 106 with the business owners 102. The recommendation engines 401 matching rules are also based on business details and other relevant information.

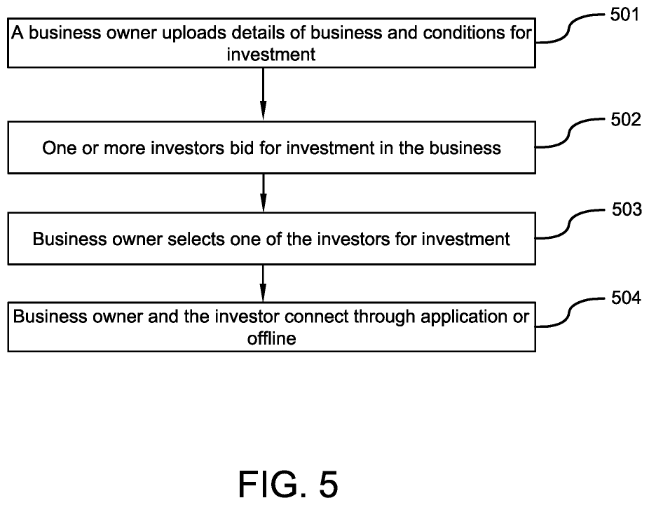

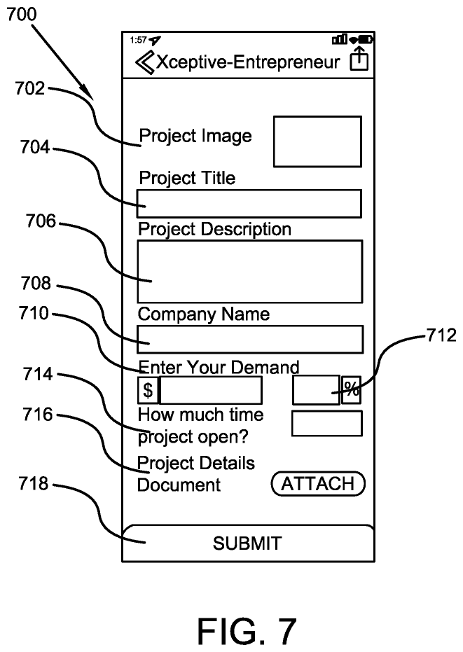

FIG. 5 illustrates a flow diagram showing steps for performing a bid by a business investor 106 for a project using the application 100 of the present invention in accordance with the disclosed architecture. As shown in FIG. 5, initially, a business owner 102 uploads the details of the business/project and the investment preferences (Block 501), wherein the project/business upload process is also described in detail in FIG. 7. One or more business investors 106 who are interested in the project for investment can bid for the business (Block 502). Then, the business owner 102, based on the bids received from one or more business investors 106, can select one (or more) of the business investors 106 for the investment (Block 503). After selection of the business investors 106, the business owner 102 and the business investors 106 can then schedule a meeting online or can connect via a phone call. The system 100 of the present invention can also provide financial and business experts to assist the business owner 102 and/or business investor 106 during the discussion and negotiation process.

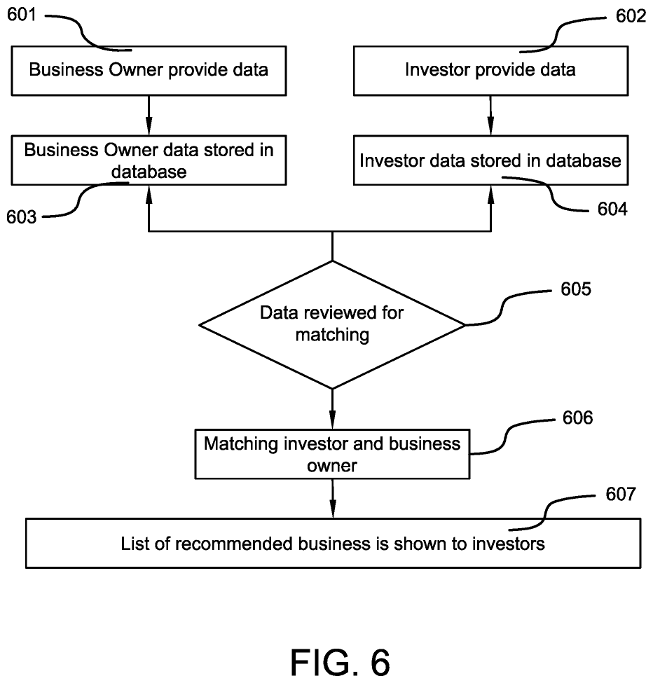

FIG. 6 illustrates a flow chart illustrating steps for automatically matching business owners 102 with business investors 106 for investments using the system 100 of the present invention in accordance with the disclosed architecture. As shown in FIG. 6, the computer-implemented method implemented by the system 100 the present invention is used for connecting business investors 106 with business owners 102 for funding the projects and businesses. As illustrated, business owners 102 provide business owner data through the web-based site, or a mobile application described (Block 601). The business owner 102 data such as personal details, business details, investment preferences and other such data is stored in a business owner profile database (Block 603). Similarly, business investors 106 provide business investor data through the web-based site, or a mobile application (Block 602). The business investor data, such as personal details, investment preferences, types of investment, and other such data is stored in an investment profile database (Block 604).

The business owner data and the business investor data are analyzed by a recommendation engine 401 for identifying matches between business investors 106 and the businesses/business owners 102 (Block 605). Based on the profile data of the business investors 106 and the business owners 102, the computer-implemented method associates the business owners 102 and the business investors 106 (Block 606). Then, the associated list of businesses is shown to business investors 106 for potential investment (Block 607). Similarly, a list of potential business investors 106 can be shown to the business owners 102.

Matching within the system 100 occurs according to specified matching rules. These matching rules can be divided into the business owner 102 and the business investor 106 matching rules. Matching rules are based on the details that are provided by the business owners 102 and the business investors 106. Business owners' matching rules are based on the business types or investment preferences. Rules may also include the location, category, type of funding, market size, market growth rates, revenue and other such data. Similarly, business investor matching rules are based on the business type, type of investment and investment preferences. Additional rules may include the investment amount, geographic location, and other such data. Further, only verified business investors 106 can run a match within the system 100. Matches are generally run only against verified business owners 102, wherein the verification of business investors 106 and business owners 102 is performed by the system 100.

FIG. 7 illustrates a perspective view of an exemplary interface for submitting a project for investment on the system 100 of the present invention in accordance with the disclosed architecture. A business owner 102 can generate a post for the investment requirements for a business using the portal/interface 700. A business owner 102 then uploads the necessary details of a business, and when the business details are verified by the system 100 a post is generated for business investors 106 to view and show investment interest.

A project image 702 such as logo or trademark can also be uploaded which can be in an image format (such as, but not limited to, .jpg, .jpeg, .png, etc.). Further, a business or project title 704 is included to identify the business, as well as a project description 706 that allows the system 100 to categorize the project listing and also allows a business investor 106 to understand the project. A company name 708 of the business owner for which the project is planned is also included in the post.

An important aspect of the project or business listing is the demand 710 and a condition 712 such as a percentage of business stake or monetary investment amount. A business owner 102 can place a time limit 714 for which the listing will be active on the application for the investment. For impressing business investors 106, the business owner 102 can upload a document 716, such as a brochure or business plan, and submit the listing using the Submit header/button 718. The listing is also verified by the system 100 before publishing.

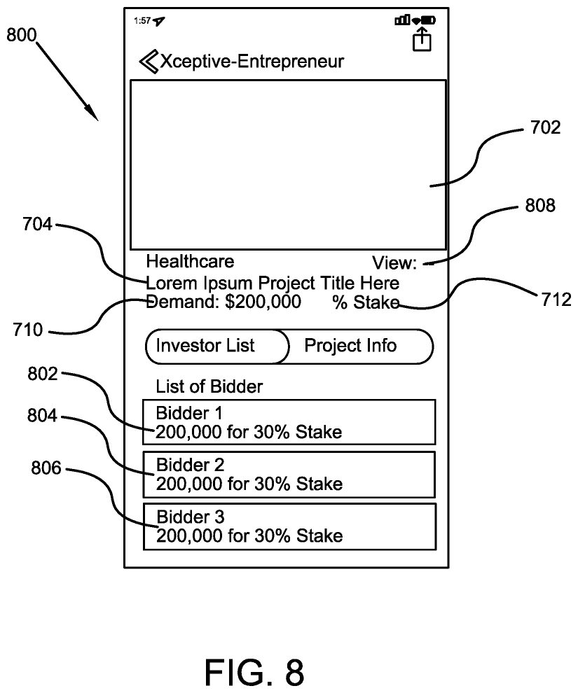

FIG. 8 illustrates a perspective view of an exemplary interface showing investment bidding status for a project on the system 100 of the present invention in accordance with the disclosed architecture. When a business investor 106 selects a business for investment, the business investor 106 details along with the investment bid are shown to the business owner 102 through the portal/interface 800. As shown, a list of business investors/bidders 802, 804, 806 who bid for the project 704 and satisfy the demand 710 and the criteria/condition 712 set by the business owner 102 are displayed on the interface 800. The portal 800 also shows the number of views 808 of the project and displays a picture 702 uploaded by the business owner while creating a listing of the project 704. The business owner 102 may then select one or more business investors 106 for investing in the project. Further, a business owner 102 can sell a 100% stake using the system/application 100 of the present invention.

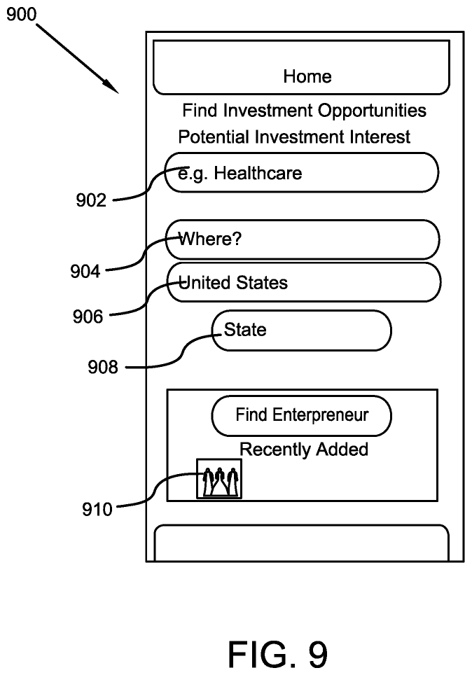

FIG. 9 illustrates an exemplary interface of the system 100 of the present invention for enabling a business investor 106 to search for businesses in which to invest based on certain search criteria in accordance with the disclosed architecture. The interface 900 is available for a user registered as a business investor 106 and not as a business owner 102. As shown, a business investor 106 can use a category 902 such as healthcare or medical devices to shortlist businesses or projects of the category or domain. To further shortlist projects, location criteria of the country 904 and state 906 can be used for viewing projects of a certain geographic area. The business investor 106 can then hit the find entrepreneur button 908 to submit the selected criteria. The interface 900 also shows the recently viewed or recently added projects 910 of the business investor and can be used as a reference or reminder for the business investor.

Accordingly, it is contemplated that the system/application 100 can be downloaded from an application store such as Google play store or Apple store. The present invention can also be used on any browser by using a website providing interfaces similar to the computer-implemented application.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system for connecting business investors with business owners” and “investment system”, “a computer-implemented application for matching business owners with business investors”, and “system” are interchangeable and refer to the system for connecting business investors with business owners 100 of the present invention. Similarly, used herein “computer-implemented application” and “application”, are interchangeable and refer to the computer-implemented application 104 of the present invention.

Notwithstanding the forgoing, the system for connecting business investors with business owners 100 of the present invention can be of any suitable configuration as is known in the art without affecting the overall concept of the invention, provided it accomplishes the above-stated objectives. One of ordinary skill in the art will appreciate that the size, configuration and specification of the components of the system for connecting business investors with business owners 100 as shown in the FIGS. are for illustrative purposes only, and that many other configurations of the system for connecting business investors with business owners 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for associating a plurality of business owners and a plurality of business investors comprising the steps of:
receiving a first set of registration details from at least one of the plurality of business owners;
receiving a second set of registration details from at least one of the plurality of business investors,
creating at least one category of businesses based on the first and second set of registration details;
matching one or more of the plurality of business owners with one or more of the plurality of business investors;
providing the one or more of the plurality of business owners with a list containing at least one recommended business investor;
providing the one or more of the plurality of business investors with a list containing at least one recommended business owner;
allowing the one or more of the plurality of business investors to express an interest in the business owners;
notifying a business owner of the interest in the business owner expressed by the one or more of the plurality of business investors; and
providing a means for the business owner and the one or more of the plurality of business investors to communicate.

2. The method of claim 1, wherein a non-transitory computer readable storage medium with an executable program interacts with the plurality of business owners and the plurality of the business investors, the executable program comprising a recommendation engine as a means for associating the plurality of business owners and the plurality of business investors.

3. The method of claim 1, wherein each of the first and second registration details is comprised of a personal data, a business information, a business preference, a business location and a set of investment terms and conditions.

4. The method of claim 1, wherein the step of matching comprises reviewing a business investor location and a business investor category.

5. The method of claim 4, wherein the step of matching further comprises reviewing a business owner category, a business owner location, and at least one term of investment.

6. The method of claim 5, wherein each of the list containing at least one recommended business investor and the list containing at least one recommended business owner are based on a preferred location.

7. The method of claim 6, wherein the list containing at least one recommended business investor includes a listing of the business investors' recent investments.

8. The method of claim 7, wherein the list containing at least one recommended business investor is ranked according to successful business investments of the at least one recommended business investor.

9. The method of claim 8, wherein each of the first and second sets of registration details is verified.

10. A computer software supported system for selecting a business investor from a plurality of business investors, the computer software supported system comprising a non-transitory computer readable storage medium with an executable program, wherein the executable program instructs a processor to:
receive a first set of registration details from at least one business owner;
receive a second set of registration details from at least one business investor;
create a plurality of categories of businesses based on the first and second set of registration details;
match the at least one business owner with the at least one business investor;
provide the at least one business owner with a list of recommended business investors;
provide the at least one business investor with a list of recommended business owners;
allow the at least one business investor to express an interest in the at least one business owner'
notify the at least one business owner of the interest; and
provide a means for communication to the business owner and to the business investor.

11. The computer software supported system of claim 10 further comprising:
a portal allowing the at least one business owner to register a set of business owner details and to show the set of business owner details to the at least one business investor, and allowing the at least one business investor to register a set of business investor details and to show the set of business investor details to the at least one business owner,
a recommendation engine that matches the at least one business owner and the at least one business investor; and
a notification module configured to:
send a notification to the business investor selected by the at least one business owner of an owner request for discussion of a business investment; and
send a notification to the at least one business owner selected by the business investor of an investor request for discussion of the business investment.

12. The computer software supported system of claim 11, wherein the set of business owner details and the set of business investor details are each comprised of a personal data, a business information, a business preference, a business location, and a plurality of investment terms and conditions.

13. The computer software supported system of claim 12, wherein the at least one business owner and the at least one business investor can search for one another using the set of business owner details and the set of business investor details as a filter.

14. The computer software supported system of claim 10, wherein the business investor can express interest in the at least one business owner through a bidding process.

15. The computer software supported system of claim 10 further comprising a central customer support service.

16. The computer software supported system of claim 15, wherein the central customer support service comprises a marketing expert, a financial expert, and a technology expert.

17. A method for matching a business owner with an investor comprising the steps of:
receiving a request for an investment from the business owner;
matching the request with at least one business investor based on a set of affinities of the at least one business investor;
allowing the at least one business investor to bid on the investment; and
notifying the business owner of the bidding of the at least one business investor.

18. The method of claim 17, wherein a non-transitory computer readable storage medium with an executable program interacts with the business owner and the at least one business investor, the executable program comprising a recommendation engine as a means for matching the business owner and the at least one business investor.

19. The method of claim 17, wherein the set of affinities of the at least one business investor is comprised of a business category, a location, and a set of terms of investment.

20. The method of claim 17, wherein the at least one business investor can search for the business owner using the set of affinities of the at least one business investor as a filter.
